(19) United States
(12) Patent Application Publication
(10) Pub. No.: US 2021/0238010 A1
(43) Pub. Date: Aug. 5, 2021

(54) METHOD AND ELEVATOR CONTROLLER FOR DETECTING A MALFUNCTION IN AN ELEVATOR

(71) Applicant: Inventio AG, Hergiswil (CH)

(72) Inventors: Martin Kusserow, Luzem (CH); Zack Zhu, Baar (CH)

(21) Appl. No.: 17/250,092

(22) PCT Filed: Jun. 13, 2019
(86) PCT No.: PCT/EP2019/065503

§ 371 Date: Nov. 24, 2020

(30) Foreign Application Priority Data
Jun. 27, 2018 (EP) 18180208.3

(51) Int. Cl. B66B 5/02; B66B 3/00; G06N 20/00; G06N 5/04

(52) U.S. Cl. CPC B66B 5/02; B66B 3/002; B66B 2201/30; G06N 5/04; G06N 20/00

(57) ABSTRACT

An elevator controller detects a malfunction such as elevator blockage in an observed elevator utilizing a method including: acquiring first data during an application phase, the first data correlating with at least one condition in the observed elevator; acquiring further data during the application phase, the further data correlating with the at least one condition in other elevators; determining a current relative behavior of the observed elevator during the application phase based on a comparison of the first data with the further data; and detecting the malfunction in the observed elevator based on an analysis of the current relative behavior. The normal relative behavior information of the observed elevator, learned in a machine learning procedure during a preceding learning phase, is taken into account upon analyzing the current relative behavior of the observed elevator. The method enables automatically detecting malfunctions in an elevator while reducing a probability of false alarms.

### FIELD

The present invention relates to a method for detecting a malfunction in an elevator. Particularly, the present invention relates to a method for detecting a temporary blockage of an elevator. Furthermore, the present invention relates to an elevator controller and a computer program product for executing or controlling the proposed method and to a computer readable medium comprising such computer program product stored thereon.

### BACKGROUND

In many buildings having more than one floor, elevators serve for transporting passengers or goods vertically between the floors. During normal function of an elevator, the elevator may be called to come to a starting floor and may then be instructed to move to a destination floor.

However, due to for example malfunctions or defects, normal function of an elevator may be disturbed or interrupted. For example, an elevator may be blocked such that its car may no more move between the floors.

Conventionally, malfunction or particularly blockage of the elevator may be detected for example upon a user of the elevator detecting the malfunction or blockage and alerting for example a responsible person in a control center.

However, in such conventional approach, the malfunction of the elevator is not recognized before the user of the elevator detects the malfunction and notifies the control center. No proactive service is possible before a user realizes the malfunction.

An alternative approach is described in KR 2017 0126821 A. Therein, an intercom unit of a sensor based intelligent emergency call system is proposed to automatically transmit an emergency call signal based on detection results of sensors such as a voice sensor, an impact detection sensor or an acceleration sensor even when a passenger does not press an emergency call. Specifically, in addition to an existing function that allows the passenger to press the emergency call button to notify of an emergency situation, the intercom unit of the present invention may immediately notify a security office or the like of an emergency situation occurring in an elevator car through sensor values of one or more among the mentioned sensors.

WO 2016/091309 A1 and WO 2009/126140A1 disclose systems for detecting a malfunction of an elevator based on measured data of this elevator.

However, it has been observed that in such alternative approach, an excessive number of false alarms may occur, each false alarm typically resulting in maintenance staff having to visit the elevator and check operation. Thereby, substantive additional work and costs may be generated.

### SUMMARY

There may be a need for an alternative method for detecting a malfunction in an observed elevator. Particularly, there may be a need for such method which allows proactive servicing of an elevator and/or minimizing a number of false alarms. Furthermore, there may be a need for such method which requires no or only minimal further hardware to be provided in an elevator compared to conventional elevators. Additionally, there may be a need for an elevator controller and for a computer program product being configured for implementing the proposed method as well as for a computer readable medium comprising such computer program product stored thereon.

According to a first aspect of the present invention, a method for detecting a malfunction in an observed elevator is described. The method comprises at least the following steps, preferably in the indicated order:

acquiring first data during an application phase, the first data correlating with at least one condition in the observed elevator;
acquiring further data during the application phase, the further data correlating with the at least one condition in other elevators;
determining a current relative behavior of the observed elevator during the application phase based on a comparison of the first data with the further data;
detecting the malfunction in the observed elevator based on an analysis of the current relative behavior.

According to a second aspect of the invention, an elevator controller comprising a data processor and a data acquisition interface is described. The elevator controller is configured to executing, performing or controlling a method according to an embodiment of the first aspect of the invention.

According to a third aspect of the invention, a computer program product is described to comprise computer readable instructions which, when performed by a processor of an elevator controller, instruct the elevator controller to one of executing, performing and controlling a method according to an embodiment of the first aspect of the invention.

According to a fourth aspect of the invention, a computer readable medium comprising a computer program product according to an embodiment of the third aspect of the invention stored thereon is proposed.

Ideas underlying embodiments of the present invention may be interpreted as being based, inter alia, on the following observations and recognitions.

As briefly indicated in the introductory portion, technical approaches have been proposed for detecting malfunctions in an elevator in order to avoid that such malfunctions may only be detected upon a passenger trying to use the defective elevator. In such prior art approaches, sensors supervising conditions in an elevator were used in order to obtain information about current conditions of the elevator and to enable determining specific malfunctions in the elevator.

However, in such prior art approaches, typically only the signals of sensors supervising conditions in a single elevator were used in order to determine the current conditions of this single observed elevator.

It has now been realized that in such prior art approaches, an excessive number of false alarms may occur. Such false alarms may be issued for example when conditions occur in the observed elevator which have similar characteristics as occurring upon malfunctions of the observed elevator but these conditions do not result from any malfunctions but for other reasons.

For example, in prior art approaches, a malfunction in the observed elevator may have been assumed in situations where the elevator car did not move for more than a predetermined time interval. Specifically, such lacking motion may have been interpreted as indicating an elevator blockage. However, the lacking motion may be the result of other conditions.

For example, an elevator installed in a public building such as a school or a shopping center may not be used during long time intervals at weekends. Such long-term lacking use of the elevator may be misinterpreted as indicating a malfunction.

In order to reduce a likelihood of such misinterpretations, it is therefore proposed herein to detect a malfunction in an observed elevator not only based on the actual behavior or conditions within this observed elevator but to correlate the behavior of the observed elevator with the actual behavior of other elevators. Such correlated behavior is referred to herein as “relative behavior”.

By analyzing the current relative behavior of an observed elevator taking into account the current behavior of other elevators, situations in which the current behavior of the observed elevator is affected not due to a malfunction of this observed elevator but due to conditions which also affect the other elevators may be recognized. Accordingly, a likelihood of false alarms may be reduced.

In the following, an embodiment of the method proposed herein will be described in relation to an example in which the malfunction to be detected is a temporary blockage of the observed elevator. Such temporary blockage may result in an elevator for various reasons and may affect conditions of the elevator in various ways. A most obvious affected condition is that the elevator car may no more move between the floors in the building. Accordingly, such type of malfunction essentially eliminates the purpose of the elevator. However, it shall be noted that the proposed method may also be used for detecting other malfunctions in an observed elevator, such other malfunctions not necessarily completely preventing a use of the elevator but limiting a use or disturbing a use of the elevator.

In order to determine the current relative behavior of the observed elevator, first data is acquired during an application phase. These first data shall correlate with at least one condition in the observed elevator. In the example of detecting a blockage of the observed elevator, the first data shall correlate with at least one condition of the observed elevator being affected by the temporary blockage of the observed elevator.

Furthermore, further data is acquired during the application phase. These further data shall correlate with the at least one condition in other elevators. In other words, the further data shall represent characteristics of the same one or more condition to which the first data correlate in the observed elevator, but this condition prevailing not in the observed elevator but in one of the other elevators. Accordingly, in the example of detecting a blockage in the observed elevator, the further data shall correlate with the at least one condition in each of multiple other elevators wherein the condition is affected by the temporary blockage of the respective other elevator.

The further data may be acquired simultaneously with the first data. Alternatively, the further data may be acquired within a common time interval together with the first data. The common time interval may be set such that the conditions within the observed elevator as represented by the first data, on the one hand, and the conditions within the other elevator as represented by the further data, on the other hand, may be compared in a meaningful manner. Accordingly, a length of the common time interval may be selected in dependence of characteristics of the observed condition. For example, the common time interval may, in some cases, be shorter than one minute whereas, in other cases, the common time interval may be as long as one or even several hours.

According to an embodiment, the first data is generated based on signals provided by sensors comprised in the observed elevator and the further data is generated based on signals provided by sensors comprised in the other elevators.

In other words, both, the first data and the further data may be acquired from sensors provided in the respective observed elevator and other elevators, these sensors issuing the data in the form of sensor signals. Such sensors may measure parameters which correlate to conditions currently prevailing in the respective elevator. Accordingly, the first data and the further data may be acquired based on such current sensor measurements. Various sensors may be applied in the observed elevator as well as in the other elevators, for example in or at the elevator car and/or at various locations or components throughout the entire elevator arrangement. The sensors may measure or detect physical parameters correlating to local conditions within the elevator.

For example, according to an embodiment, the first data and the further data correlate to

a number of door motions occurring during a time interval,

a number of elevator trips occurring during a time interval,

a change in car occupancy occurring during a time interval,

distances travelled during a time interval,

an amount of time passed since a last trip, and/or

an amount of time passed since a last door motion.

For example, information about motions such as an opening motion or a closing motion of elevator doors may be acquired. The elevator door may be an elevator car door or an elevator shaft door. The information may be obtained from a sensor observing a respective elevator door. For example, mechanical sensors, electric sensors, magnetic sensors, inductive sensors, optical sensors or various other sensors may be actuated upon any door motion occurring. Additionally or alternatively, the information about the door motion may be obtained from an elevator control unit controlling the respective elevator door. Accordingly, a number of motions of the respective elevator door during a given time interval may be counted. Furthermore, an amount of time which has passed since the respective elevator door has been moved for the last time may be determined. Each such information may correlate with conditions within the respective elevator and may therefore be taken as the first or further data, respectively, or as part of the first or further data, respectively.

Additionally or alternatively, an information about whether an elevator car performs a trip may be acquired. For example, sensors within an elevator shaft may detect the presence of the elevator car and/or a passing-by of the elevator car. Again, various types of different sensors may be applied for such purpose. Additionally or alternatively, the information about an elevator trip may be obtained from the elevator control unit. Optionally, an information about a distance travelled by the elevator car may be acquired. Accordingly, a number of elevator trips of a respective elevator car during a given time interval may be counted. Furthermore, an amount of time which has passed since a last trip may be determined. As a further alternative, distances travelled by the elevator car during a given time interval may be determined. Again, each such information may correlate with conditions within the respective elevator and may therefore be taken as the first or further data, respectively, or as part of the first or further data, respectively.

As a further alternative or supplement, an information about a current load in the elevator car may be acquired. For example, a sensor connected to the bottom of the elevator car may sense a weight acting onto this bottom. Alternatively, sensors may sense loads acting on ropes holding the elevator car. As a further alternative, a load in the elevator car may be determined based on characteristics of an elevator drive upon moving the elevator car. Further alternatives for determining the current load of the elevator car may be used. The information about the current load of the elevator car generally corresponds to information about a car occupancy. Car occupancy and, particularly, information about changes in such car occupancy typically correlate with conditions within the respective elevator and may therefore also be taken as the first or further data, respectively, or as part of the first or further data, respectively.

It shall be noted that the first and further data, respectively, may also correlate to other conditions or parameters and may be acquired based on signals provided for example by other sensors. Generally, the method described herein may be agnostic to the specific type of first and further data as long as these data somehow correlate with a condition in the respective elevator which condition is affected by the malfunction to be detected.

According to an embodiment, additionally to the current relative behavior of the observed elevator during the application phase, a relative behavior of the observed elevator may be determined in a learning phase preceding the application phase. Such relative behavior of the observed elevator during the learning phase may for example be determined during a long period of time and may be assumed to represent normal operation of the elevator. Accordingly, such relative behavior is referred to herein as “normal relative behavior”. The normal relative behavior may be determined by:

(i) acquiring first data during the learning phase, the first data correlating with the at least one condition in the observed elevator;
(ii) acquiring further data during the learning phase, the further data correlating with the at least one condition in other elevators; and
(iii) determining the normal relative behavior of the observed elevator during the learning phase based on a comparison of the first data with the further data.
Accordingly, the normal relative behavior may be determined in a similar way as the above described determining of the current relative behavior, but the determination of the normal relative behavior is executed during the learning phase, i.e. prior to determining the current relative behavior in the application phase. In other words, the normal relative behavior may be learned in the learning phase in a machine learning procedure. Then, in the subsequent application phase, the step of detecting the malfunction in the observed elevator may include an analysis not only of the current relative behavior but an analysis of the current relative behavior in comparison with the normal relative behavior.

Expressed in different words, the current behavior of the observed elevator may not only be compared to the current behavior of the other elevators in an analysis of the current relative behavior but, additionally, such current relative behavior may also be compared to the normal relative behavior as learned in the preceding learning phase.

Accordingly, it could for example be recognized when the current behavior of the observed elevator significantly deviates from the current behavior of the other elevators. This, in general, could indicate a malfunction in the observed elevator. However, there may also be situations in which such deviation of the current behavior of the observed elevator is within a normal range of acceptable behaviors. Such circumstances may be determined based on the comparison with the normal relative behavior as learned in the preceding learning phase.

Explained with reference to the example briefly described further above, several elevators comprised in a school may change their current behavior during weekends as the school and its elevators are not used during weekends.

By comparing the current behavior of an observed elevator only with its preceding behavior, such change in current behavior could be interpreted as indicating a malfunction. However, by analyzing the current behavior relative to the behavior of the other elevators in the school, it may become apparent that such change in current behavior may be acceptable and may not indicate any malfunction as the change in current behavior of the observed elevator coincides with a similar change in current behavior of the other elevators such that no or only a minor change in the current relative behavior is given.

In another situation, when in this example the current behavior of the observed elevator suddenly changes during normal school days, this may indicate a malfunction of the observed elevator. However, even in such situation, the change in current behavior may be acceptable and may not indicate any malfunction. For example, the observed elevator is hardly used on Fridays as on Fridays classes located in the part of the school building served by the observed elevator do have sports lessons and do therefore not use the observed elevator for accessing their classrooms. Such extraordinary situations may be learned in the machine learning procedure during the learning phase.

Accordingly, upon additionally comparing the current relative behavior of the observed elevator with the previously learned normal relative behavior, such extraordinary situations may be recognized and issuing of a false alarm may be suppressed.

According to an embodiment, the further data is acquired in other elevators which have previously been determined to have a certain similarity to the observed elevator.

In other words, when there are multiple elevators and data correlating with functions of the elevators are available for each of these multiple elevators, it may be beneficial to, in the proposed method, not use the further data acquired for all of these multiple elevators. Instead, it may be beneficial to select those elevators from a pool of accessible multiple elevators which have a certain similarity to the observed elevator. Therein, the observed elevator and the other elevators may be assumed to have a certain similarity in case, under normal conditions, they show a similar behavior.

For example, elevators being installed close to each other in a same building and/or elevators serving for a same or similar purpose may have a sufficient similarity.

Taking into account only further data from other elevators having a specific similarity to the observed elevator may help in avoiding false alarms upon detecting the malfunction in the observed elevator.

According to an embodiment, the similarity between the observed elevator and one of the other elevators is determined in a learning phase preceding the application phase, which application phase includes the detecting the malfunction in the observed elevator.

In other words, whether or not the observed elevator and one of the other elevators may be interpreted as having a sufficient similarity may be determined during the learning phase. For example, in this learning phase, the behavior of the observed elevator and the behavior of the other elevator may be compared and if both behaviors are similar to a certain extent, these two elevators may be accepted as having the sufficient similarity.

According to an embodiment, the similarity between the observed elevator and one of the other elevators is determined based upon

information relating to a physical distance between the observed elevator and the other elevator,

information relating to an application of the observed elevator and the other elevator, and/or

information relating to a temporal segment in which the first data and the further data is acquired.

Expressed differently, whether or not the observed elevator and the other elevator have a sufficient similarity may be determined based on various factors.

For example, a distance between both elevators may correlate with the similarity between these elevators. For example, elevators within a same building may have a similar use profile, i.e. there may be a similarity between these elevators as the people moving within the same building may use both elevators in a similar way. This may be particularly true if the two elevators are located in close proximity within the building. However, even between elevators located in different buildings, there may be a degree of similarity. For example, in a large multiplicity of elevators being located throughout various countries or regions, those elevators being installed in a same country or same region may have a degree of similarity. For example, when there is a public holiday in a first country but no such holiday in a neighboring second country, elevators in the first country might experience a different current behavior compared to normal working days. Accordingly, by limiting the determination of the relative current behavior to those elevators comprised in a close proximity or in the same country or region, false alarms may be avoided.

As another example, information about an application of an elevator may be taken into account upon determining whether it is similar to another elevator or not. Therein, the application may for example correlate to the purpose of the elevator as determined for example by the type of building in which the elevator is located. For example, all elevators located in schools may be interpreted as having a same application and may be determined as showing sufficient similarity as their behavior may be similar due to for example school schedules and/or school holidays influencing elevator usage in a similar way at all of these schools. Similarly, all elevators located in shopping centers may be interpreted as having a same application as, generally, passenger traffic in such shopping centers may similarly depend on times of the day and therefore elevator usage may behave similar throughout all of these shopping centers.

As a further example, information about a temporal segment, i.e. about a period of time, in which the first and further data is acquired may be taken into account upon determining whether an elevator is similar to another elevator or not. For example, when the behavior of elevators in schools is compared during a learning phase of only two weeks, elevators in schools located in different countries or regions may be taken as showing a sufficient similarity when both schools are used in a similar way due to holidays applying to both schools during these two weeks. However, on a longer timescale, i.e. when the behavior of the elevators is not compared only during holidays but also during normal school times, both elevators in the different schools may behave very differently and may not show sufficient similarity.

According to an embodiment, the method is executed in an elevator controller receiving

sensor data acquired by a multiplicity of sensors distributed throughout the observed elevator and a multiplicity of the other elevators, and/or

control data generated in an elevator control unit of the observed elevator and control data generated in an elevator control unit of a multiplicity of the other elevators.

In other words, the elevator controller may monitor, supervise and/or control operation of a multiplicity of elevators including the elevator to be observed and the other elevators. For example, the elevator controller may be part of a remote control center in which operation of a large variety of elevators throughout multiple buildings or even throughout multiple areas or countries may be monitored. The method proposed herein may then be executed in such elevator controller.

For such purpose, the elevator controller may acquire sensor data acquired by a multiplicity of sensors. The sensors may be distributed throughout both, the observed elevator and the other elevators. Various different types of sensors may be applied as indicated further above.

Additionally or alternatively, the elevator controller may acquire control data generated in a control unit of the observed elevator and the other elevators, respectively. Such control unit controls the operation of the respective elevator and may therefore provide control data which correlate with the at least one function in the observed elevator and the other elevators, respectively. Accordingly, such control data may be used as first and further data in the proposed method.

When a malfunction in the observed elevator is detected using the method described herein, such information may be used for example for alerting service staff such that the malfunction may be repaired. Accordingly, in a best scenario, malfunctions may be detected automatically and may be repaired before any customers are negatively affected. On the other side, false alerting of service staff may be minimized with the method proposed herein.

Embodiments of the method proposed herein may be executed, performed or controlled in an elevator controller. For such purpose, the elevator controller may comprise a data processor and a data acquisition interface. The data processor may process data acquired via the data acquisition interface. Particularly, the data processor may process data which serve as first data and further data in the method proposed herein. Such data may be acquired via the data acquisition interface using for example hardwiring between the elevator controller and the elevators and their sensors and/or elevator control units, respectively. Alternatively or additionally, wireless data transmission may be applied.

The proposed method may be implemented using hardware, software or a combination of both. Particularly, the computer program product proposed herein may comprise computer readable instructions instructing the processor of the elevator controller such as to execute, perform or control the proposed method. Therein, the computer program product may be programmed in any suitable computer language. Furthermore, the computer program product may be stored on any suitable computer readable medium such as for example a CD, a DVD, a flash memory, etc. Alternatively, the computer program product may be stored on a computer or server from which it may be downloaded via a network such as the Internet.

It shall be noted that possible features and advantages of embodiments of the invention are described herein partly with respect to a method for detecting a malfunction in an observed elevator and partly with respect to an elevator controller configured for implementing such method. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows an arrangement of multiple elevators in which malfunctions may be detected with a method in accordance with the present invention.

FIG. 2 shows a flowchart of a possible implementation of a method in accordance with the present invention.

The figures are only schematic and not to scale. Same reference signs refer to same or similar features.

### DETAILED DESCRIPTION

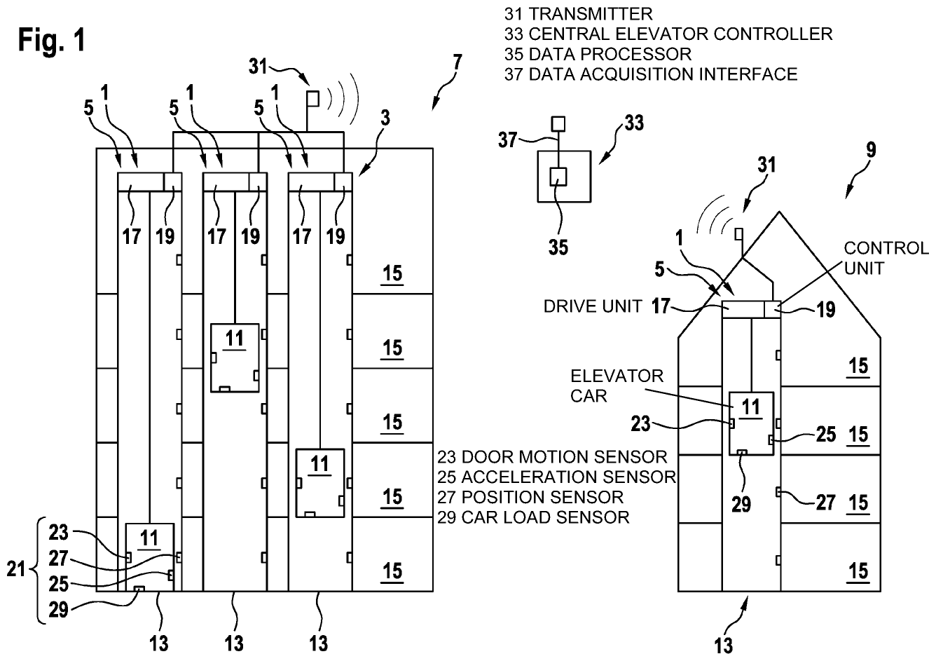

FIG. 1 shows an arrangement of several elevators 1 including an observed elevator 3 and several other elevators 5 in a first building 7 and a second building 9. Each elevator 1 comprises an elevator car 11 which may be moved throughout an elevator shaft 13 such as to be accessible from various floors 15. Each of the elevator cars 11 is displaced using a drive unit 17 controlled by a control unit 19.

In each of the elevators 1, a multiplicity of sensors 21 is provided for measuring parameters relating to various physical conditions. For example, a door motion sensor 23 may measure parameters which may change upon a car door or a shaft door being opened and/or closed. An acceleration sensor 25 may measure accelerations acting onto the elevator car 11. A position sensor 27 may measure a current position of the elevator car 11 throughout the elevator shaft 13. A car load sensor 29 may measure a load currently acting onto the elevator car 11 thereby allowing indirectly determining changes in car occupancy.

Signals provided by the sensors 21 or data correlating therewith may be transmitted from each of the elevators 1 via transmitters 31 towards a central elevator controller 33. Such central elevator controller 33 may be located in a remote control center being far away from the buildings 7, 9. The central elevator controller 33 may comprise a data acquisition interface 37 for receiving the signals or data transmitted by the transmitters 31. Furthermore, the central elevator controller 33 comprises a data processor 35 for processing the data received via the data acquisition interface 37.

The central elevator controller 33 may execute or control a method for detecting a malfunction in the observed elevator 3 in accordance with an embodiment of the present invention.

For such purpose, first data correlating with at least one condition in the observed elevator 3 may be acquired during an application phase. For example, such first data may be derived from signals of one or more of the sensors 21. Particularly, first data may be derived from signals of one or more sensors 21 supervising conditions which are influenced upon occurrence of the malfunction to be detected, i.e. for example supervising conditions which are influenced upon occurring of a blockage of the observed elevator 3.

Furthermore, further data is acquired during the application phase, such further data also relating to the same one condition as supervised in the observed elevator 3 but prevailing in one of the other elevators 5. For example, such further data may be derived from signals of one or more sensors 21 supervising conditions which are influenced upon the same type of malfunction to be detected, i.e. for example supervising conditions which are influenced upon occurrence of a blockage in the other elevator 5.

Subsequently, based on the acquired first data and further data and processing these first and further data in the data processor 35, the elevator controller 33 determines a current relative behavior of the observed elevator 3 during the application phase based on a comparison of the first data with the further data.

Finally, based on an analysis of the current relative behavior, the malfunction in the observed elevator 3 may be detected.

In a preferred embodiment, not only the current relative behavior of the observed elevator 3 is analyzed, but also a normal relative behavior of this observed elevator 3 is taken into account upon detecting the malfunction in the observed elevator 3. For such purpose, the normal relative behavior is determined in a machine learning procedure during a learning phase. In principle, the normal relative behavior is determined using a similar procedure as used for determining the current relative behavior but based on first and further data acquired during the learning phase instead of the application phase.

Furthermore, in a preferred embodiment, only the further data acquired in other elevators 5 having previously been determined to have a certain similarity to the observed elevator 3 are taken into account upon determining the current relative behavior of the observed elevator 3.

For example, other elevators 5 being located in the same first building 7 as the observed elevator 3 may be assumed to have a sufficient similarity to the observed elevator 3 as an elevator usage profile throughout the same first building 7 may be assumed to be similar for all of the elevators 1 comprised in this first building 7.

Overall, a system is proposed which may learn regular operational behavior of an observed elevator 3 from its deviance with respect to other elevators 5 for example located nearby and/or having another type of similarity with respect to the observed elevator 3.

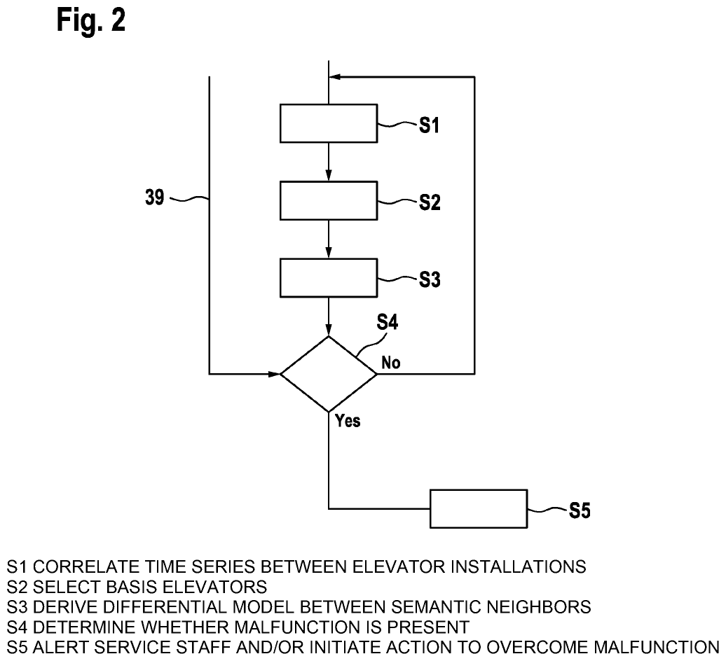

Subsequently, a specific implementation of an embodiment of the method for detecting a malfunction in the observed elevator 3 will be explained with reference to the flowchart shown in FIG. 2.

Roughly summarized, such embodiment may comprise five steps. In a first step S1, a time series between elevator installations may be correlated. A pairwise correlation matrix resulting therefrom may then be processed in a second step S2 in which basis elevators are selected based on for example correlation threshold. Resulting from such second step, clusters of semantically related elevator installations are used in a third step S3 for deriving a differential model between semantic neighbors. Two other possible ways to select clusters of semantically related elevator installations used in the third step are by similar physical distance (e.g. elevators in the same building) or by activation time (e.g. elevators operating during the same time periods like 9-5 on workdays). Upon learning the relationship of the observed elevator installation as related to basis elevators during a learning phase, the observed elevator may be monitored and malfunctions may be detected based on a maximum differential tolerance. For such purpose, in a fourth step S4, it is then decided whether or not a malfunction such as a blockage of the elevator is present in the observed elevator. For such blockage decision, first and further current data 39 and a current relative behavior of the observed elevator 3 derived therefrom may be compared with data representing a normal relative behavior of the observed elevator 3 as determined during the learning phase. If, in such decision step, a blockage of the observed elevator 3 is detected, service staff may be alerted in a final step S5 or other actions for overcoming the detected malfunctions may be initiated.

In a specific example of this embodiment, in the first step S1, multi-dimensional signals may be given for all elevator installations in a fleet. A pairwise correlation matrix may then be sought, where entries of such correlation matrix depict a correlation in the input signals for pairs of elevator installations in a portfolio.

A calculation of a calculation metric may be determined by a practitioner, e.g. Spearman's rho may be applied for rank based correlation.

Furthermore, multi-dimensional input signals may be first projected onto a lower-dimensional space (e.g. a single dimensional time series) before calculating the correlation matrix, applying for example Principle Component Analysis.

Then, in the second step S2, for the whole portfolio of elevator installations, elevator installations may be clustered into “semantically similar” groups. Parameters for clustering such installations may depend on the practitioner's choosing. For example, physical distance between elevator installations (e.g. within one building, one city block, etc.) may be chosen. Alternatively or additionally, existing semantic grouping of buildings (e.g. groups installations of different hotel/hospital/school buildings) may be chosen. As a further alternative or supplement, a temporal segment in which to compare the correlation threshold (e.g. only correlation of input signals from the last 4 weeks are considered) may be chosen.

Subsequently, in the third step S3, given installations within one semantic cluster, a differential baseline is constructed by subtracting each elevator installation's input signals from a weighted average of the other elevator installation's input signals. The weighting may be given by the semantic similarity of installations defined in Step S2.

As such, the differential baseline of each installation i.e. may be calculated as:

$${D}_{i} = \frac{1}{len ( S ) - 1} {\sum }_{j} {w}_{i , j} * {M}_{j} ∀ j \neq i ∈ S$$

where Dᵢ is the differential baseline for installation i; S is the set of installations belonging to the same semantic cluster; w_{i,j} is the semantic similarity between installation i and j; Mⱼ is the matrix of input signals where the columns are the different signal types and the rows are mapped semantic time periods (e.g. hour 0 of a weekday, hour 1 of a weekday, . . . hour 23 of a weekday, hour 0 of a weekend day, hour 1 of a weekend day . . . ).

Additionally, there are many other possible ways to calculate a differential baseline of each installation.

It is to be noted that semantically meaningful time periods may be used to aggregate absolute time in the training period. The specific aggregation method and interval of aggregation remains a choice of the practitioner (e.g. averages of hourly time bins for weekdays and weekend days).

For each installation, a model may be learned from the ‘normal’ behavior of the differential baseline using standard anomaly detection methods, e.g. One-Class Support Vector Machines. These models may learn from a matrix of data (Dᵢ) to define a ‘normal’ space of operations. In this context, the historical differential baseline provided by Dᵢ characterizes how a specific installation operates with respect to other semantically related installations.

Finally, having trained the model, it may be applied on current data. The blockage estimation step requires that current data is processed the same way as the training data to derive differential vectors. These differential vectors may then be fed to the anomaly detection model to determine whether the vector is anomalous or not. If anomalous, operations personnel may be notified. Otherwise, the data may be transferred back into the training pipeline as additional training data for continuous model updates.

Briefly summarized, embodiments of the present invention allow overcoming shortcomings of conventional approaches for detecting malfunctions in an elevator. Particularly, it may no more be necessary that a customer complaint has to trigger a call-back and/or a site visit upon a malfunction occurring in an elevator. Instead, the approach proposed herein allows automatically detecting malfunctions such as blockage in an elevator with a low probability of false alarms. Particularly, the proposed approach is less susceptible to false positives (false alarms) that may arise from the examination of single installations. For example, lack of operation of a specific elevator at the beginning of a school day would not raise a blockage alert if all elevators in the building are also lacking in operation. Provisioning and consideration of operational rules may be significantly reduced or minimized as blockage detection may be based on relative behavior of installations against its neighbors. An unsupervised approach may eliminate a need for manual labelling of blockage scenarios. A solution may be independent of an input signal source/automatic pruning of irrelevant input signals. The present approach may enable a proactive service call before customer realize a malfunction. Furthermore, the present approach may be applicable in modernization or NI (new installation) installations where additional sensing hardware is deployed without connection to a shaft information system or elevator control unit.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. A method for detecting a malfunction in an observed elevator, the method comprising the steps of:
acquiring first data during an application phase, the first data correlating with at least one condition in the observed elevator;
acquiring further data during the application phase, the further data correlating with the at least one condition in other elevators;
determining a current relative behavior of the observed elevator during the application phase based on a comparison of the first data with the further data; and
detecting a malfunction in the observed elevator based on an analysis of the current relative behavior.

14. The method according to claim 13 wherein the malfunction is a temporary blockage of the observed elevator and wherein the first data and the further data correlate with conditions of an elevator being affected by a temporary blockage.

15. The method according to claim 13 including determining a normal relative behavior of the observed elevator in a learning phase preceding the application phase by the steps of:
acquiring other first data during the learning phase, the other first data correlating with the at least one condition in the observed elevator;
acquiring other further data during the learning phase, the other further data correlating with the at least one condition in the other elevators;
determining the normal relative behavior of the observed elevator during the learning phase based on a comparison of the other first data with the other further data acquired during the learning phase; and
wherein the step of detecting the malfunction in the observed elevator includes an analysis of the current relative behavior in comparison with the normal relative behavior.

16. The method according to claim 13 wherein the other elevators have previously been determined to have a certain similarity to the observed elevator.

17. The method according to claim 16 wherein the certain similarity between the observed elevator and one of the other elevators is determined in a learning phase preceding the application phase, which application phase includes the step of detecting the malfunction in the observed elevator.

18. The method according to claim 17 wherein the certain similarity between the observed elevator and the one of the other elevators is determined based upon at least one of:
information relating to a physical distance between the observed elevator and the one of the other elevators;
information relating to an application of the observed elevator and the one of the other elevators; and
information relating to a temporal segment in which the first data and the further data are acquired.

19. The method according to claim 13 wherein the first data is generated based on signals provided by sensors supervising conditions in the observed elevator and the further data is generated based on signals provided by sensors supervising conditions in the other elevators.

20. The method according to claim 13 wherein the first data and the further data correlate to at least one of:
a number of door motions occurring during a time interval;
a number of elevator trips occurring during a time interval;
a change in car occupancy occurring during a time interval;
distances travelled during a time interval;
an amount of time passed since a last trip; and
an amount of time passed since a last door motion.

21. The method according to claim 13 wherein the method is executed in an elevator controller receiving at least one of:
the first data acquired by a multiplicity of sensors distributed throughout the observed elevator and the further data acquired by a multiplicity of sensors distributed throughout the other elevators; and
control data generated in an elevator control unit of the observed elevator and control data generated in an elevator control unit of at least one of the other elevators.

22. The method according to claim 13 including alerting a service staff to the detected malfunction.

23. The method according to claim 13 including initiating an action to overcome the detected malfunction.

24. An elevator controller comprising:
a data acquisition interface receiving the first data and the further data; and
a data processor connected to the data acquisition interface and being adapted to at least one of execute, perform and control the method according to claim 13 to detect the malfunction in the observed elevator.

25. A computer program product comprising computer readable instructions which, when performed by a processor of an elevator controller, instruct the elevator controller to at least one of execute, perform and control the method according to claim 13 to detect the malfunction in the observed elevator.

26. A non-transitory computer readable medium comprising the computer program product according to claim 25 stored thereon.
